(19) United States
(12) Patent Application Publication
(10) Pub. No.: US 2009/0204497 A1
(43) Pub. Date: Aug. 13, 2009

(54) Centralized Media Production System and Method

(75) Inventors: Jason Coon, Minneapolis, MN (US); Lesley Inman, Savage, MN (US); Brett D. Slocum, Minneapolis, MN (US); Chris R. Moewes-Bystrom, Crystal, MN (US); Michael A. Thompson, Coon Rapids, MN (US); Cindy Lou Ferris, Minneapolis, MN (US)

Correspondence Address: NORTH OAKS PATENT AGENCY, 45 ISLAND ROAD, NORTH OAKS, MN, 55127, US

(73) Assignee: DIGITAL RIVER, INC., Eden Prairie, MN (US)

(21) Appl. No.: 12/364,322

(22) Filed: Feb. 2, 2009

Related U.S. Application Data
(60) Provisional application No. 61/026,898, filed on Feb. 7, 2008.

(51) Int. Cl. G06Q 30/00; G06F 17/30; G06F 15/16

(52) U.S. Cl. 705/14; 707/104.1; 705/26; 709/204; 707/E17.032; 707/E17.044

(57) ABSTRACT

A centralized media production system and its method of use is described. Web services are utilized in order processing in an electronic commerce system and fulfillment requests in a vendor manufacturing system. An XML-formatted WSDL file is used for submitting order and fulfillment requests. This process and system provides a way for software manufacturers to fulfill customer orders for physical copies of downloadable software, without being restricted to a particular e-commerce platform while allowing the manufacturer to interface with multiple vendors for fulfillment.

This application claims the benefit of U.S. Provisional Application No. 61/026,898 filed 7 Feb. 2008, entitled “Centralized Media Production System,” which is incorporated herein by reference.

### FIELD OF THE INVENTION

The present invention relates to remote manufacturing of software media over a network. More particularly, the present invention relates to a system and related method for creating and managing production of physical copies of software across a number of e-commerce platforms and fulfillment vendors.

### BACKGROUND OF THE INVENTION

The sale and distribution of software via the e-commerce channel provides several advantages over distribution through traditional sales channels, particularly when the distribution may be made by internet download. A sale of downloadable product avoids considerable problems and expense in regard to warehouse expenses, shipping costs, returns, end of life merchandise, limited catalog and limited stock. Downloaded software has an unlimited inventory, it is never out of stock and the publisher can always provide the latest version. The consumer is able to buy software and use it immediately. There is no waiting for delivery, no shipping costs, no lost software keys. There is no delay between the decision to buy and the actual purchase. Along with these advantages and features, however, the consumer frequently wants a physical copy of the software. On-demand manufacturing and fulfillment of a physical copy of downloadable software offers these benefits and eliminates concerns surrounding backorder or cancellation of orders.

A software manufacturer may host an online store on its own platform or contract with e-commerce providers or partners in order to sell and distribute its products. The e-commerce provider may have a number of platforms hosting online stores and a number of media vendors located throughout the world, which are able to provide manufacturing and fulfillment services. Such a system may take advantage of standardized web services and protocols, such as XML, WSDL and SOAP.

Extensible markup language (XML) allows systems, even incompatible ones, to share data via the internet by providing a plain text structure for carrying information from one system to another. The Web Services Description Language, or WSDL, is the document or “contract,” written in XML, which describes the web service. Simple Object Access Protocol (SOAP) provides a simple and lightweight mechanism for exchanging structured and typed information between systems in a decentralized, distributed environment using XML. SOAP does not itself define any application semantics such as a programming model or implementation specific semantics; rather it defines a simple mechanism for expressing application semantics by providing a modular packaging model and encoding mechanisms for encoding data within modules. This allows SOAP to be used in a large variety of systems ranging from messaging systems to remote procedure calls (RPC).

SOAP consists of three parts: The SOAP envelope construct defines an overall framework for expressing what is in a message; who should deal with it, and whether it is optional or mandatory. The SOAP encoding rules defines a serialization mechanism that can be used to exchange instances of application-defined datatypes. The SOAP RPC representation defines a convention that can be used to represent remote procedure calls and responses.

Additionally, the World Wide Web Consortium (W3C) defines a Web service as a software system designed to support interoperable Machine to Machine interaction over a network. Web services are frequently just Web application programming interfaces (APIs) that can be accessed over a network, such as the Internet, and executed on a remote system hosting the requested services.

Web services have greatly expanded and simplified the capacity for communications and data sharing between systems. However, software manufacturers may utilize e-commerce systems operating on multiple platforms and multiple vendors for disc fulfillment. While communications between systems may be simplified, integrating each e-commerce platform with each vendor can be a complicated and high-maintenance endeavor. It also creates additional issues with reporting, order management, shipping and billing across these distributed systems. A solution is required that will avoid the necessity of having all platforms interfacing with all vendors. The present invention provides a solution to these needs and other problems, and offers other advantages over the prior art.

### BRIEF SUMMARY OF THE INVENTION

The present invention is related to a software distribution system that solves the above-mentioned problems. A Centralized Media Production System (CMPS) provides a unique, modular solution to ordering, manufacturing and shipping physical copies of software on demand. A preferred embodiment of this invention can be configured for one or more e-commerce platform(s) and one or more fulfillment vendor(s). The system's modularity allows platforms and vendors to be added to the system with a minimal amount of code and test. The CMPS database allows for reporting across platforms and vendors.

In accordance with a preferred embodiment of the invention, a system providing for the distribution of product files (executables, binaries, etc) for the creation of compact discs (CDs), digital video discs (DVDs) or any other type of optical disc, media or format is described. This embodiment allows a manufacturer to produce, on demand, software media for purchases and avoid maintenance of stock of product. Such a system acts as an intermediary, centralized system, interfacing with one or more e-commerce platforms to receive, process and distribute order information, and with one or more software media production vendors to distribute, process and receive fulfillment information.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 is a context diagram of a centralized media production system (CMPS) interfacing with multiple platforms and multiple vendors.

FIG. 2 depicts the components of a CMPS.

FIGS. 3A-3D are a data model for a preferred embodiment of a CMPS database.

FIG. 4 is an illustration of a disc graphic with data provided by the CMPS.

FIG. 5 is an illustration of an autorun menu installed on the manufactured disc.

### DETAILED DESCRIPTION

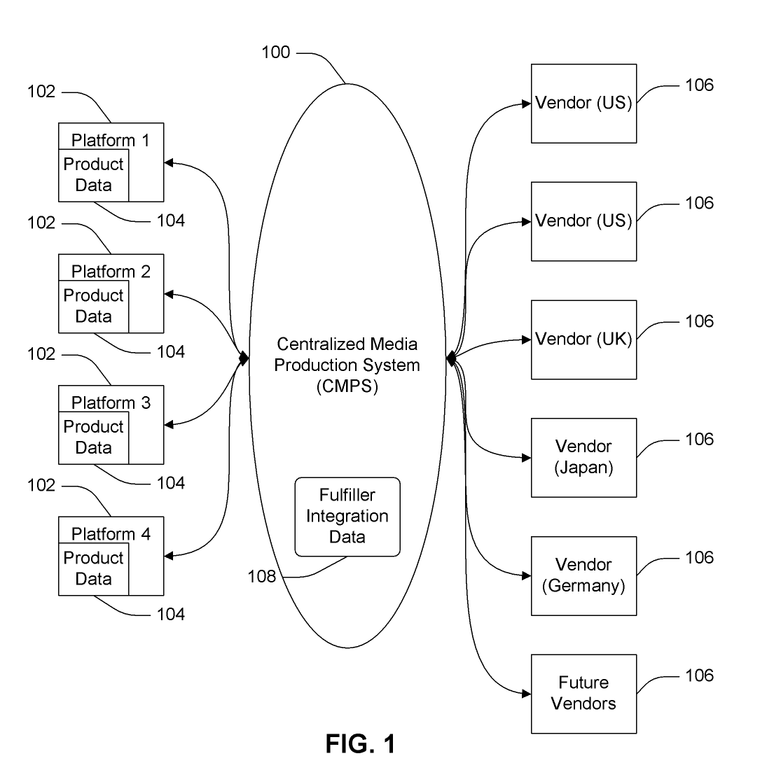

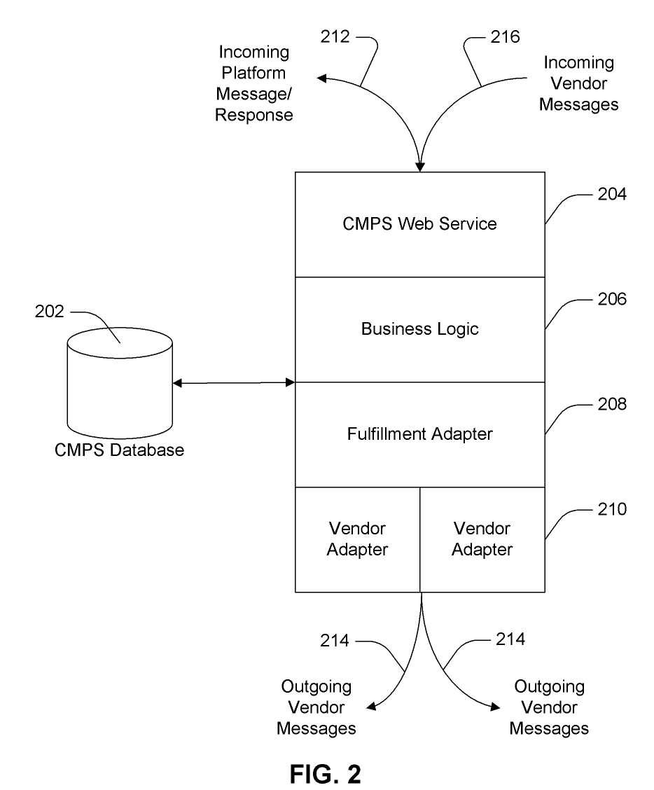

A preferred embodiment of a CMPS 100 system is illustrated in FIG. 1. The system is peripheral to, and interfacing with, at least one e-commerce platform 102, storing product and order data 104, and at least one software manufacturing vendor system 106. Such a configuration allows for easy integration of any number of additional platforms and vendors. FIG. 1 illustrates an embodiment of the invention with multiple platforms 102 and vendors 106 in context. The components of a preferred embodiment of a CMPS 100 is illustrated in FIG. 2. A CMPS 100 providing these benefits discussed above may consists of a database 202, a web service component or other API or messaging mechanism 204, a business logic component 206, a fulfillment adapter 208, and vendor adapter(s) 210.

The flow through the CMPS 100 may be in real time or spooled for batch processing. Messages are received from the e-commerce platform(s) 212, processed through the CMPS 100 and sent to the vendor for fulfillment 214. When the order has been fulfilled, the vendor communicates back to the CMPS 216.

Referring to the components in FIG. 2, the database 202 stores the data parsed from incoming messages passed from both the e-commerce platforms 212 and the vendor systems 216. The database 202 may be used as a central reporting data repository for orders fulfilled through the system. This is particularly helpful when a manufacturer runs online stores hosted on more than one e-commerce platform 102. Instead of reporting from each system for order management and operations functions, the centralized repository 202 can report on orders created across systems 102. The CMPS database 202 includes the location of all products carried by the online stores supported by the e-commerce provider. Products may be stored on the e-commerce platform 104, on the vendor site, or elsewhere. The CMPS database 202 receives, through an additional API, identifiers and locations of the products that may be ordered from each platform. The location may be, for example, the URL for a file repository. CMPS may pass this information to the fulfillment vendor, who locates and downloads the product for burning; this ensures that the latest copy is always provided on the newly manufactured disc.

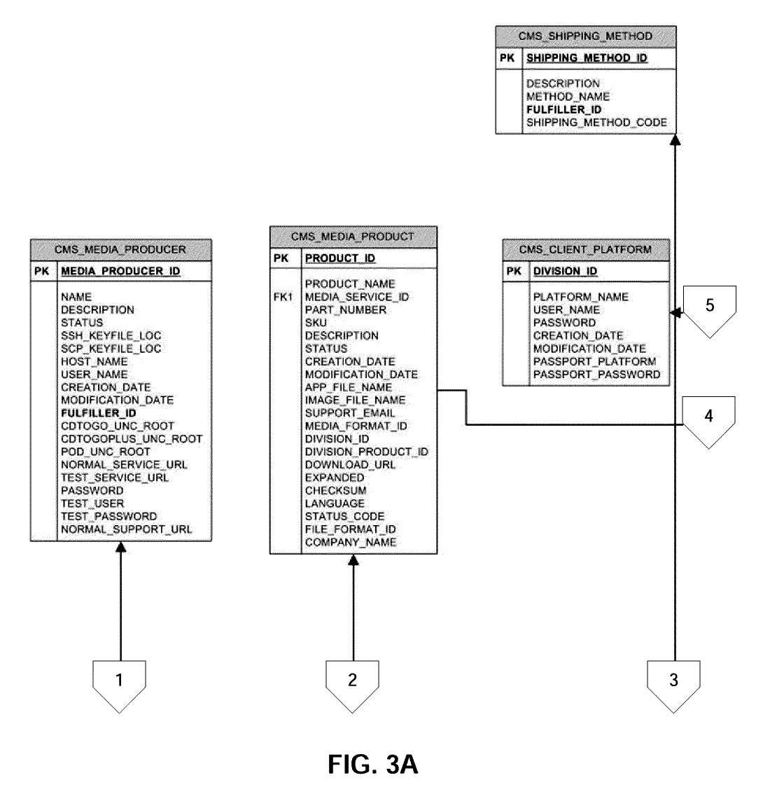

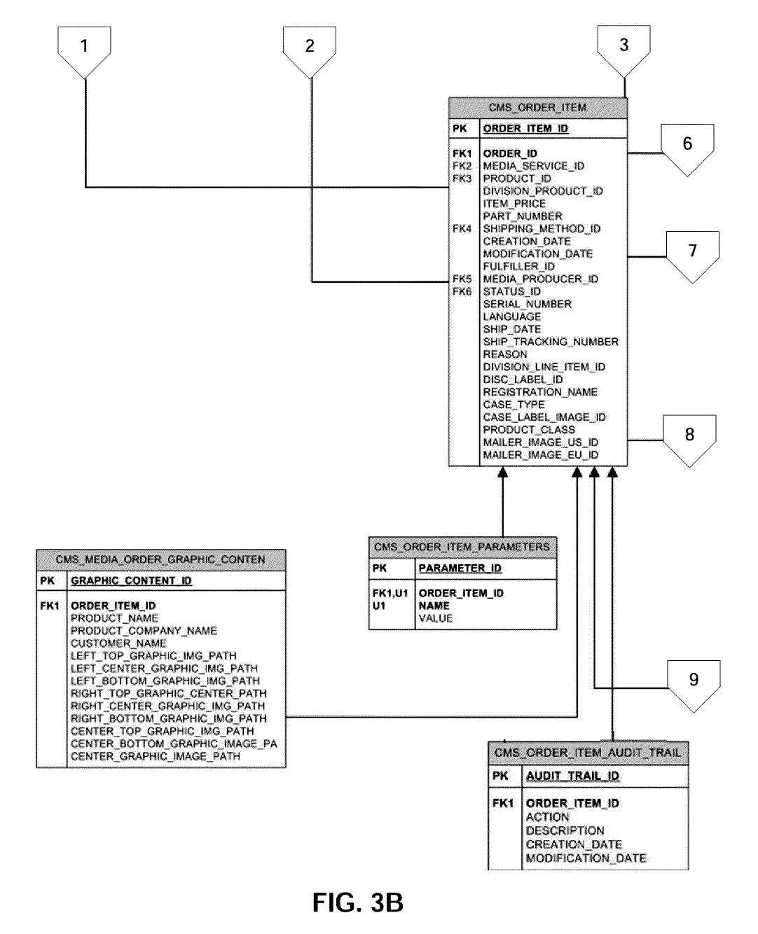

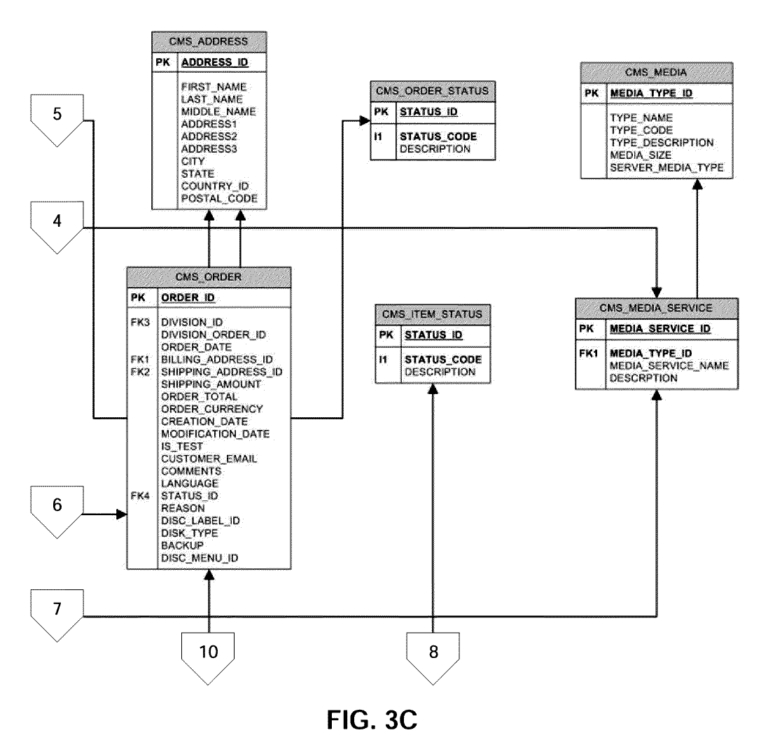

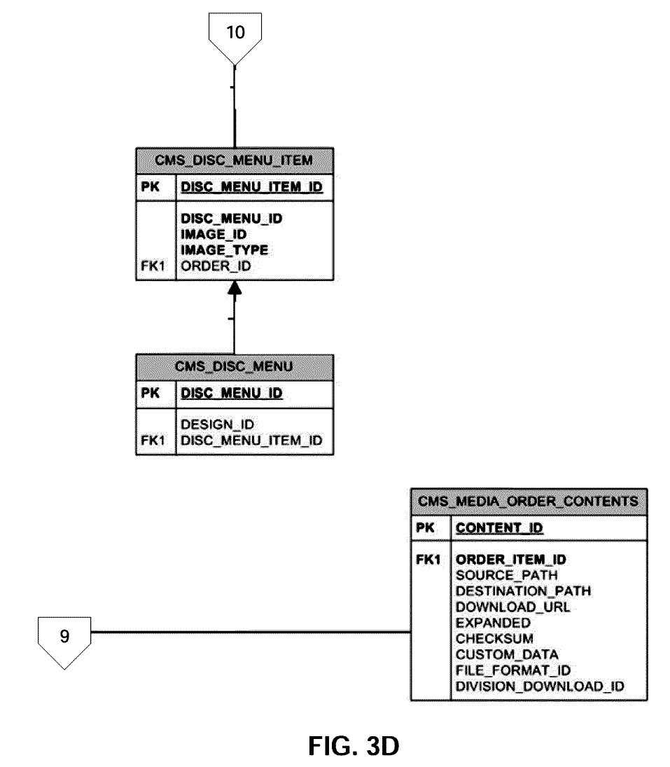

FIG. 3 is a sample data model for a database for a preferred embodiment. A preferred feature of the database is its ability to handle multi-byte character sets, since this is required for full language support of Asian manufacturers.

Referring again to FIG. 2, a preferred embodiment of the invention utilizes a web service component 204 for messaging; a person skilled in the art would recognize other messaging systems would work as well. A web service such as the one described here, may utilize SOAP protocol as described above.

These web services preferably are implemented in a data processing system configured as a server in accordance with a preferred embodiment of the present invention. The data processing system may be a symmetric multiprocessor (SMP) system including a plurality of processors and connected to system bus. Alternatively, a single processor system may be employed. Also connected to system bus is memory controller/cache, which provides an interface to local memory. An I/O bus bridge is connected to system bus and provides an interface to the I/O bus. Memory controller/cache and the I/O bus bridge also may be integrated together. A peripheral component interconnect (PCI) bus bridge connected to the I/O bus provides an interface to a PCI local bus. Communications links to manufacturers may be provided through a network adapter connected to the PCI local bus. A memory-mapped graphics adapter and hard disk may also be connected to the I/O bus. Those of ordinary skill in the art will appreciate that the hardware described above may vary. For example, other peripheral devices, such as optical disk drives and the like, also may be used in addition to or in place of the hardware depicted. The described example is not meant to imply architectural limitations with respect to the present invention.

In the preferred embodiment, messages have a request-response pattern common in web services. Messages sent from the e-commerce system platforms 102, 212 to the CMPS 100 may receive a response of either requested data or acknowledgments 212. Messages also flow between CMPS and the vendor system(s) 214, 216. Messages in this embodiment cover services to implement specific operations, for instance: adding a disk order, lookup status of previously submitted orders, re-burn a disk on demand, add new products, and update existing products. The E-commerce platforms 102 transmit messages to the CMPS 100, including requests for fulfillment and status, and the CMPS 100 responds, if required by the message dialogue. Sample message information that may be provided for a preferred embodiment, and schema definitions of some of the APIs are provided in Tables 1 through 5, below. An example of an entire WSDL with an alternative, but similar set of messages and overall structure is included in Table 6. One skilled in the art will recognize that many kinds of messages are possible and the messages offered here are offered as examples only, and are not meant to be limiting in any way.

TABLE 1
E-commerce Platform-Side Messages

| Message | Description |
|---|---|
| createCMPSOrder | This operation may create an order on the CMPS system. Each order may |
| | contain one or more items with the details on what needs to go on each disc |
| | (programming, information, graphics, product identifiers, file path or location). |
| | A platform may provide the product for download via URL. |
| | The CMPS may respond to a successful receipt of this operation with a |
| | SUCCESS acknowledgment. |
| lookupCMPSOrder | A platform may request the status of a previously submitted order(s) using this |
| | operation. For input parameters, the API may accept a parameter such as an |
| | orderID provided in the response of the createCMPSOrder call or a date |
| | range. |
| | The CMPS may respond to a successful receipt of this operation with the |
| | status of the order requested. |
| createProduct | A createProduct operation may create a product record within the CMPS |
| | system. Once created successfully, a platform may receive a CMPS product |
| | identifier, which can be used in the createCMSPSOrder request for placing an |
| | order against the product. |
| | The CMPS may respond to a successful receipt of this operation with the |
| | CMPS product identifier, which is used as the product identifier in the |
| | createCMPSOrder |
| updateProduct | This operation may update a previously created product. It may be used to |
| | update the status or any other product related information. |
| lookupProduct | A platform may request a status of a product in the catalog using this |
| | operation. |
| reburnOrder | A platform may request a complete re-burn of a previously submitted order |
| | using this operation. |
| sendPendingOrders | This operation may be used to send any orders that were not sent from CMPS |
| | to the media producer due to producer service down or a manual setting in |
| | CMPS database. |
| updateOrder | This operation may provide the ability to update any information about the |
| | order, such as customer information, product information and status. |

TABLE 2
E-commerce Platform-Side Example Messages and Sample Code

| Message | Sample XML Code |
|---|---|
| Create CMPS | <soap:Envelope xmlns:soap=http://schemas.xmlsoap.org/soap/envelope/ |
| Order Request | xmlns:xsd=“http://www.w3.org/2001/XMLSchema” |
| | xmlns:xsi=“http://www.w3.org/2001/XMLSchema-instance”> |
| | <soap:Body> |
| | <orderRequest xmlns=“http://ws.cmps.digitalriver.com”> |
| | <divisionOrderID>pac-fit-1234561173909538215</divisionOrderID> |
| | <divisionID>gC</divisionID> |
| | <orderAmount>10.99</orderAmount> |
| | <shippingAmount>4.99</shippingAmount> |
| | <orderCurrency>USD</orderCurrency> |
| | <billingAddress> |
| | <firstName>Sairam</firstName> |
| | <lastName>Rekapalli</lastName> |
| | <address1>13900 Chestnut DR</address1> |
| | <address2>#302</address2> |
| | <city>Minneapolis</city> |
| | <state>MN</state> |
| | <countryID>US</countryID> |
| | </billingAddress> |
| | <shippingAddress> |
| | <firstName>Sairam</firstName> |
| | <lastName>Rekapalli</lastName> |
| | <address1>13900 Chestnut DR</address1> |
| | <address2>#302</address2> |
| | <city>Minneapolis</city> |
| | <state>MN</state> |
| | <countryID>US</countryID> |
| | </shippingAddress> |
| | <orderItemsArray> |
| | <cmpsOrderItem> |
| | <divisionProductID>pac-fit- |
| | 12341171063838217</divisionProductID> |
| | <cmpsProductID>251551</cmpsProductID> |
| | <itemPrice>6.0</itemPrice> |
| | <shippingMethodID>UPSGround</shippingMethodID> |
| | <mediaServiceType>POD</mediaServiceType> |
| | </cmpsOrderItem> |
| | </orderItemsArray> |
| | </orderRequest> |
| | </soap:Body> |
| | </soap:Envelope> |
| Create Order | <soap:Envelope xmlns:soap=“http://schemas.xmlsoap.org/soap/envelope/” |
| Response | xmlns:xsd=“http://www.w3.org/2001/XMLSchema” |
| | xmlns:xsi=“http://www.w3.org/2001/XMLSchema-instance”> |
| | <soap:Body> |
| | <orderResponse xmlns=“http://ws.cmps.digitalriver.com”> |
| | <responseDate>2007-03-14T16:59:16.277-05:00</responseDate> |
| | <responseStatus>SUCCESS</responseStatus> |
| | <orderInformation> |
| | <cmpsOrderID>252502</cmpsOrderID> |
| | <divisionOrderID>pac-fit-1234561173909556104</divisionOrderID> |
| | <divisionID>gC</divisionID> |
| | <cmpsOrderItems> |
| | <cmpsOrderItem> |
| | <cmpsOrderItemID>252352</cmpsOrderItemID> |
| | <divisionProductID>pac-fit- |
| | 12341171063838217</divisionProductID> |
| | <cmpsProductID>251551</cmpsProductID> |
| | <status>SUBMITTED</status> |
| | </cmpsOrderItem> |
| | </cmpsOrderItems> |
| | </orderInformation> |
| | </orderResponse> |
| | </soap:Body> |
| | </soap:Envelope> |
| Create Product | <soap:Envelope xmlns:soap=“http://schemas.xmlsoap.org/soap/envelope/” |
| Request | xmlns:xsd=“http://www.w3.org/2001/XMLSchema” |
| | xmlns:xsi=“http://www.w3.org/2001/XMLSchema-instance”> |
| | <soap:Body> |
| | <createProductRequest xmlns=“http://ws.cmps.digitalriver.com”> |
| | <divisionID>gC</divisionID> |
| | <divisionProductID>pac-fit-12341173909533141</divisionProductID> |
| | <productInformation> |
| | <sku>SK11</sku> |
| | <description>PacificPODProduct:Created For Testing</description> |
| | <productName>PacificPODProduct</productName> |
| | <mediaServiceType>POD</mediaServiceType> |
| | <partNumber>PN100</partNumber> |
| | <price>0.0</price> |
| | </productInformation> |
| | </createProductRequest> |
| | </soap:Body> |
| | </soap:Envelope> |
| Create Product | <soap:Envelope xmlns:soap=“http://schemas.xmlsoap.org/soap/envelope/” |
| Response | xmlns:xsd=“http://www.w3.org/2001/XMLSchema” |
| | xmlns:xsi=“http://www.w3.org/2001/XMLSchema-instance”> |
| | <soap:Body> |
| | <createProductResponse xmlns=“http://ws.cmps.digitalriver.com”> |
| | <responseMessage>SUCCESS</responseMessage> |
| | <cmpsProductID>253000</cmpsProductID> |
| | </createProductResponse> |
| | </soap:Body> |
| | </soap:Envelope> |
| Update Product | <soap:Envelope xmlns:soap=“http://schemas.xmlsoap.org/soap/envelope/” |
| Request | xmlns:xsd=“http://www.w3.org/2001/XMLSchema” |
| | xmlns:xsi=“http://www.w3.org/2001/XMLSchema-instance”> |
| | <soap:Body> |
| | <updateProductRequest xmlns=“http://ws.cmps.digitalriver.com”> |
| | <divisionID>gC</divisionID> |
| | <cmpsProductID>251551</cmpsProductID> |
| | <productStatus>ACTIVE</productStatus> |
| | <productInformation> |
| | <productName>PacificPODProduct-Update</productName> |
| | <price>0.0</price> |
| | </productInformation> |
| | </updateProductRequest> |
| | </soap:Body> |
| | </soap:Envelope> |
| Update Product | <soap:Envelope xmlns:soap=“http://schemas.xmlsoap.org/soap/envelope/” |
| Response | xmlns:xsd=“http://www.w3.org/2001/XMLSchema” |
| | xmlns:xsi=“http://www.w3.org/2001/XMLSchema-instance”> |
| | <soap:Body> |
| | <updateProductResponse xmlns=“http://ws.cmps.digitalriver.com”> |
| | <responseMessage>SUCCESS</responseMessage> |
| | </updateProductResponse> |
| | </soap:Body> |
| | </soap:Envelope> |

TABLE 3
E-commerce Platform-Side Example Message Schema Definitions

| | | |
|---|---|---|
| ElementName | Type | Description |

CMPSOrderRequestType

| | | |
|---|---|---|
| orderDate | dateTime | Date on which the order was submitted to commerce |
| | | platform |
| divisionOrderID | DivisionOrderIDType | Unique identifier of the order on the commerce platform |
| divisionID | DivisionIDType | Unique identifier of the commerce platform |
| orderAmount | float | Total Order Amount |
| shippingAmount | float | Total Shipping Amount |
| orderCurrency | CurrencyType | Currency of the order |
| billingAddress | AddressType | Billing address on the order |
| shippingAddress | AddressType | Shipping address on the order |
| cmpsOrderItems | CMPSOrderItemsType | order items |

CMPSOrderItemsType

| | | |
|---|---|---|
| divisionProductID | DivisionProductIDType | Product Identifier on the commerce platform |
| cmpsProductID | int | Product Identifier on the CMPS platform |
| itemPrice | float | Price of the item |
| shippingMethodID | string | Shipping Method ID provided by CMPS |
| partNumber | string | Part number for identification by fulfillment partner |
| mediaServiceType | string | Type Of media (Vendor) |
| productName | string | ProductName |
| productCompanyName | string | Company name to which the product belongs to |
| orderContents | OrderContentsType | Contents that need to be burned on to the Media |
| graphicContents | GraphicContentsType | Graphic images/files that form the label that gets |
| | | printed on the Media |

OrderContentsType

| | | |
|---|---|---|
| sourcePath | FilePathType | Path to the source file |
| downloadURL | string | URL to download product for external fulfillment |
| fileSize | int | Size of the file |
| destinationPath | FilePathType | Path to the destination on the Media |

GraphicContentsType

| | | |
|---|---|---|
| leftTopGraphicImagePath | FilePathType | Path to the image file for Left Top Region |
| leftCenterGraphicImagePath | FilePathType | Path to the image file for Left Center Region |
| leftRightGraphicImagePath | FilePathType | Path to the image file for Left Bottom Region |
| rightTopGraphicImagePath | FilePathType | Path to the image file for Right Top Region |
| rightCenterGraphicImagePath | FilePathType | Path to the image file for Right Center Region |
| rightBottomGraphicimagePath | FilePathType | Path to the image file for Right Bottom Region |
| centerTopGraphicImagePath | FilePathType | Path to the image file for Center Top Region |
| centerCenterGraphicImagePath | FilePathType | Path to the image file for Center Center Region |
| centerBottomGraphicImagePath | FilePathType | Path to the image file for Center Bottom Region |

AddressType

| | | |
|---|---|---|
| firstName | string | First name of the customer |
| lastName | string | Last name of the customer |
| middleName | string | Middle name of the customer |
| address1 | string | Part1 of the address |
| address2 | string | Part2 of the address |
| address2 | string | Part3 of the address |
| city | string | City to which the order should be shipped |
| state | string | State to which the order should be shipped |
| countryID | string | ISO Country code |
| postalCode | string | zip or postal code of the address |

CMPSOrderResponseType

| | | |
|---|---|---|
| responseDate | dateTime | Date on which the response came from CMPS |
| responseStatus | string | Indicates whether order was succesful or not. Possible |
| | | Values: SUCCESS, FAILURE |
| responseMessage | string | Additional message indicating the failure |
| orderInformation | OrderInformationType | Order Information |

OrderInformationType

| | | |
|---|---|---|
| cmpsOrderID | int | CMPS Order Number |
| divisionOrderID | DivisionOrderIDType | Commerce platform's Unique ORDER ID |
| divisionID | DivisionIDType | Unique identifier of the commerce platform |
| orderItems | OrderItemInformationType | Items on the order |

OrderItemInformationType

| | | |
|---|---|---|
| cmpsOrderItemID | int | CMPS Order ItemID number |
| divisionProductID | DivisionProductIDType | Product identifier given by platform |
| cmpsProductID | int | CMPS Product Identifier |
| status | String | Status of the Item |
| trackingNumber | String | Tracking number if item is shipped from warehouse |
| shipDate | dateTime | date on which the item is shipped from warehouse |

LookupCMPSOrderRequestType

| | | |
|---|---|---|
| cmpsOrderID | int | CMPS Unique Order Identifier |
| dateRange | DateRangeType | Range of dates |
| divisionID | DivisionIDType | Unique identifier of the commerce platform |

LookupCMPSOrderResponseType

| | | |
|---|---|---|
| responseMessage | string | Additional message indicating the failure |
| cmpsOrder | OrderInformationType | Order Information |

CreateProductRequestType

| | | |
|---|---|---|
| divisionID | DivisionIDType | Unique identifier of the commerce platform |
| divisionProductID | DivisionProductIDType | Product identifier given by platform |
| productInformation | ProductInformationType | Information on the product |

CreateProductResponseType

| | | |
|---|---|---|
| responseMessage | string | Indicates SUCCESS/FAILURE |
| cmpsProductID | int | CMPS Product Identifier |

ProductInformationType

| | | |
|---|---|---|
| sku | String | SKU of the product |
| description | String | Description of the product - MaxLength 128 |
| productName | String | Name of the product |
| mediaServiceType | String | Type of the media we want the product to go on. Eg: |
| | | CD2GO/POD |
| partNumber | String | Shipper Part Number If Any |
| price | float | Price of the product |
| currency | CurrencyType | ISO Currency Code of the price |

UpdateProductRequestType

| | | |
|---|---|---|
| divisionID | DivisionIDType | Unique identifier of the commerce platform |
| divisionProductID | DivisionProductIDType | Product identifier given by platform |
| cmpsProductID | int | CMPS Product Identifier |
| productStatus | ProductStatusType | Status of the product |
| productInformation | ProductInformationType | Information on the product |

UpdateProductResponseType

| | | |
|---|---|---|
| responseMessage | string | Indicates SUCCESS/FAILURE |

DateRangeType

| | | |
|---|---|---|
| startDate | dateTime | Start Date of the Search |
| endDate | dateTime | Start Date of the Search |

TABLE 4
Vendor-Side Messages

| Message | Description |
|---|---|
| orderRequest | The fulfillment request formatted and transmitted by the |
| | CMPS, which includes all of the details required for |
| | production including customer shipping information, the |
| | location of the product and the graphics required on the |
| | label. |
| orderStatus | Provides the order status at any point after the order has |
| | been submitted. |
| Product feed | Retrieves the location of the product so the vendor may |
| | download the product onto its system. |

TABLE 5
Vendor-Side Example Message and XML Code

| Message | Sample XML |
|---|---|
| orderRequest | <soapenv:Envelope |
| | xmlns:soapenv=“http://schemas.xmlsoap.org/soap/envelope/” |
| | xmlns:ws=“http://ws.cmps.digitalriver.com”> |
| | <soapenv:Header/> |
| | <soapenv:Body> |
| | <ws:orderRequest> |
| | <ws:divisionOrderID>pac-123456</ws:divisionOrderID> |
| | <ws:divisionID>pacific</ws:divisionID> |
| | <ws:orderAmount/> |
| | <ws:shippingAmount/> |
| | <ws:orderCurrency/> |
| | <ws:billingAddress> |
| | <ws:firstName>John</ws:firstName> |
| | <ws:lastName>Smith</ws:lastName> |
| | <ws:address1>123 Main Street</ws:address1> |
| | <ws:city>Springfield</ws:city> |
| | <ws:state>IL</ws:state><ws:countryID>US</ws:countryID> |
| | <ws:postalCode>34567</ws:postalCode></ws:billingAddress> |
| | <ws:shippingAddress> |
| | <ws:firstName>?</ws:firstName> |
| | <ws:lastName>?</ws:lastName> |
| | <ws:address1>?</ws:address1> |
| | <ws:city>?</ws:city> |
| | <ws:countryID>?</ws:countryID> |
| | </ws:shippingAddress> |
| | <ws:isTest>true</ws:isTest><ws:orderItemsArray> |
| | <!--1 or more repetitions:--> |
| | <ws:cmpsOrderItem> |
| | <ws:divisionProductID>pac-111111</ws:divisionProductID> |
| | <ws:itemPrice>?</ws:itemPrice> |
| | <ws:shippingMethodID>?</ws:shippingMethodID> |
| | <ws:partNumber>123456</ws:partNumber> |
| | <ws:mediaServiceType>CD2GO</ws:mediaServiceType> |
| | <ws:productName>Portable Hole</ws:productName> |
| | <ws:productCompanyName>Acme, Inc.</ws:productCompanyName> |
| | <ws:serialNumber>654322</ws:serialNumber> |
| | <ws:orderContents> |
| | <ws:orderContent> |
| | <ws:sourcePath>/b5/Rimage/ViewCred.exe</ws:sourcePath> |
| | <ws:destinationPath>/dir1</ws:destinationPath> |
| | </ws:orderContent> |
| | </ws:orderContents> |
| | <ws:graphicContents> |
| | <ws:leftTopGraphicImagePath>/b5/PHYS_ON_DEMAND/DR/images/blank.bmp |
| | </ws:leftTopGraphicImagePath> |
| | <ws:leftCenterGraphicImagePath>/b5/PHYS_ON_DEMAND/DR/images/blank.bmp |
| | </ws:leftCenterGraphicImagePath> |
| | <ws:leftBottomGraphicImagePath>/b5/PHYS_ON_DEMAND/DR/images/blank.bmp |
| | </ws:leftBottomGraphicImagePath> |
| | <ws:rightTopGraphicImagePath>/b5/PHYS_ON_DEMAND/DR/images/blank.bmp |
| | </ws:rightTopGraphicImagePath> |
| | <ws:rightCenterGraphicImagePath>/b5/PHYS_ON_DEMAND/DR/images/blank.bmp |
| | </ws:rightCenterGraphicImagePath> |
| | <ws:rightBottomGraphicImagePath>/b5/PHYS_ON_DEMAND/DR/images/blank.bmp |
| | </ws:rightBottomGraphicImagePath> |
| | <ws:centerTopGraphicImagePath>/b5/PHYS_ON_DEMAND/DR/images/blank.bmp |
| | </ws:centerTopGraphicImagePath> |
| | <ws:centerBottomGraphicImagePath>/b5/PHYS_ON_DEMAND/DR/images/blank.bmp |
| | </ws:centerBottomGraphicImagePath> |
| | <ws:centerCenterGraphicImagePath>/b5/PHYS_ON_DEMAND/DR/images/blank.bmp |
| | </ws:centerCenterGraphicImagePath> |
| | </ws:graphicContents> |
| | </ws:cmpsOrderItem> |
| | </ws:orderItemsArray> |
| | </ws:orderRequest> |
| | </soapenv:Body> |
| | </soapenv:Envelope> |
| orderResponse | <soap:Envelope xmlns:soap=“http://schemas.xmlsoap.org/soap/envelope/” |
| | xmlns:xsd=“http://www.w3.org/2001/XMLSchema” |
| | xmlns:xsi=“http://www.w3.org/2001/XMLSchema-instance”> |
| | <soap:Body> |
| | <orderResponse xmlns=“http://ws.cmps.digitalriver.com”> |
| | <responseDate>2007-09-21T12:10:49.995-05:00</responseDate> |
| | <responseStatus>SUCCESS</responseStatus> |
| | <orderInformation> |
| | <cmpsOrderID>200532</cmpsOrderID> |
| | <divisionOrderID>pac-123456</divisionOrderID> |
| | <divisionID>pacific</divisionID> |
| | <cmpsOrderItems> |
| | <cmpsOrderItem> |
| | <cmpsOrderItemID>200493</cmpsOrderItemID> |
| | <divisionProductID>pac-111111</divisionProductID> |
| | <cmpsProductID>0</cmpsProductID> |
| | <status>SUBMITTED</status> |
| | </cmpsOrderItem> |
| | </cmpsOrderItems> |
| | </orderInformation> |
| | </orderResponse> |
| | </soap:Body> |
| | </soap:Envelope> |

TABLE 6
Web Service Definition Language (WSDL)
Web Service Message Code

```
<?xml version=“1.0” encoding=“UTF-8” ?>
- <wsdl:definitions targetNamespace=“http://ws.cmps.digitalriver.com”
    xmlns:soapenc=“http://schemas.xmlsoap.org/soap/encoding/”
    xmlns:wsdl=“http://schemas.xmlsoap.org/wsdl/” xmlns:tns=“http://ws.cmps.digitalriver.com”
    xmlns:xsd=“http://www.w3.org/2001/XMLSchema”
    xmlns:wsdlsoap=“http://schemas.xmlsoap.org/wsdl/soap/”
    xmlns:soap=“http://schemas.xmlsoap.org/soap/envelope/”>
  - <wsdl:types>
    - <xsd:schema xmlns:xsd=“http://www.w3.org/2001/XMLSchema”
        attributeFormDefault=“qualified” elementFormDefault=“qualified”
        jaxb:version=“1.0” targetNamespace=“http://ws.cmps.digitalriver.com”
        xmlns:jaxb=“http://java.sun.com/xml/ns/jaxb”>
      - <xsd:complexType name=“CMPSOrderRequestType”>
        - <xsd:sequence>
          <xsd:element maxOccurs=“1” minOccurs=“0” name=“orderDate”
              type=“xsd:dateTime” />
          <xsd:element name=“divisionOrderID”
              type=“tns:DivisionOrderIDType” />
          <xsd:element name=“divisionID” type=“tns:DivisionIDType” />
          <xsd:element maxOccurs=“1” minOccurs=“0” name=“orderAmount”
              type=“xsd:float” />
          <xsd:element maxOccurs=“1” minOccurs=“0”
              name=“shippingAmount” type=“xsd:float” />
          <xsd:element maxOccurs=“1” minOccurs=“0”
              name=“orderCurrency” type=“tns:CurrencyType” />
          <xsd:element name=“billingAddress” type=“tns:AddressType” />
          <xsd:element name=“shippingAddress” type=“tns:AddressType” />
          <xsd:element maxOccurs=“1” minOccurs=“0”
              name=“customerEmail” type=“xsd:string” />
          <xsd:element maxOccurs=“1” minOccurs=“0” name=“isTest”
              type=“xsd:boolean” />
          <xsd:element name=“orderItemsArray”
              type=“tns:OrderItemsArrayType” />
          </xsd:sequence>
        </xsd:complexType>
      - <xsd:complexType name=“AddressType”>
        - <xsd:sequence>
          <xsd:element maxOccurs=“1” minOccurs=“1” name=“firstName”
              type=“xsd:string” />
          <xsd:element maxOccurs=“1” minOccurs=“1” name=“lastName”
              type=“xsd:string” />
          <xsd:element maxOccurs=“1” minOccurs=“0” name=“middleName”
              type=“xsd:string” />
          <xsd:element maxOccurs=“1” minOccurs=“1” name=“address1”
              type=“xsd:string” />
          <xsd:element maxOccurs=“1” minOccurs=“0” name=“address2”
              type=“xsd:string” />
          <xsd:element maxOccurs=“1” minOccurs=“0” name=“address3”
              type=“xsd:string” />
          <xsd:element maxOccurs=“1” minOccurs=“1” name=“city”
              type=“xsd:string” />
          <xsd:element maxOccurs=“1” minOccurs=“0” name=“state”
              type=“xsd:string” />
          <xsd:element maxOccurs=“1” minOccurs=“1” name=“countryID”
              type=“tns:CountryCodeType” />
          <xsd:element maxOccurs=“1” minOccurs=“0” name=“postalCode”
              type=“xsd:string” />
          </xsd:sequence>
        </xsd:complexType>
      - <xsd:complexType name=“OrderItemsArrayType”>
        - <xsd:sequence>
          <xsd:element maxOccurs=“unbounded” minOccurs=“1”
              name=“cmpsOrderItem” type=“tns:CMPSOrderItemsType” />
          </xsd:sequence>
        </xsd:complexType>
      - <xsd:complexType name=“CMPSOrderItemsType”>
        - <xsd:sequence>
          <xsd:element name=“divisionProductID”
              type=“tns:DivisionProductIDType” />
          <xsd:element maxOccurs=“1” minOccurs=“0”
              name=“cmpsProductID” type=“xsd:int” />
          <xsd:element maxOccurs=“1” minOccurs=“0” name=“itemPrice”
              type=“xsd:float” />
          <xsd:element maxOccurs=“1” minOccurs=“0”
              name=“shippingMethodID” type=“tns:ShippingMethodIDType”
              />
          <xsd:element maxOccurs=“1” minOccurs=“0” name=“sku”
              type=“xsd:string” />
          <xsd:element maxOccurs=“1” minOccurs=“0” name=“description”
              type=“tns:ProductDescriptionType” />
          <xsd:element maxOccurs=“1” minOccurs=“0” name=“supportEmail”
              type=“xsd:string” />
          <xsd:element maxOccurs=“1” minOccurs=“0” name=“partNumber”
              type=“xsd:string” />
          <xsd:element name=“mediaServiceType”
              type=“tns:MediaServiceType” />
          <xsd:element name=“mediaFormatType”
              type=“tns:MediaFormatType” />
          <xsd:element name=“productName” type=“xsd:string” />
          <xsd:element maxOccurs=“1” minOccurs=“0”
              name=“productCompanyName” type=“xsd:string” />
          <xsd:element maxOccurs=“1” minOccurs=“0” name=“language”
              type=“tns:LanguageType” />
          <xsd:element maxOccurs=“1” minOccurs=“0” name=“serialNumber”
              type=“xsd:string” />
          <xsd:element maxOccurs=“1” minOccurs=“0”
              name=“orderContents” type=“tns:OrderContentsArrayType” />
          <xsd:element maxOccurs=“1” minOccurs=“0”
              name=“graphicContents” type=“tns:GraphicContentsType” />
          </xsd:sequence>
        </xsd:complexType>
      - <xsd:complexType name=“OrderContentsArrayType”>
        - <xsd:sequence>
          <xsd:element maxOccurs=“unbounded” minOccurs=“1”
              name=“orderContent” type=“tns:OrderContentsType” />
          </xsd:sequence>
        </xsd:complexType>
      - <xsd:complexType name=“OrderContentsType”>
        - <xsd:sequence>
          <xsd:element maxOccurs=“1” minOccurs=“0” name=“sourcePath”
              type=“tns:FilePathType” />
          <xsd:element maxOccurs=“1” minOccurs=“0”
              name=“downloadURL” type=“xsd:string” />
          <xsd:element maxOccurs=“1” minOccurs=“0” name=“fileSize”
              type=“xsd:int” />
          <xsd:element maxOccurs=“1” minOccurs=“0”
              name=“destinationPath” type=“tns:FilePathType” />
          <xsd:element maxOccurs=“1” minOccurs=“0” name=“checksum”
              type=“xsd:string” />
          <xsd:element maxOccurs=“1” minOccurs=“0” name=“customData”
              type=“xsd:string” />
          <xsd:element maxOccurs=“1” minOccurs=“0” name=“expanded”
              type=“xsd:boolean” />
          </xsd:sequence>
        </xsd:complexType>
      - <xsd:complexType name=“GraphicContentsType”>
        - <xsd:sequence>
          <xsd:element maxOccurs=“1” minOccurs=“0”
              name=“leftTopGraphicImagePath” type=“tns:FilePathType” />
          <xsd:element maxOccurs=“1” minOccurs=“0”
              name=“leftCenterGraphicImagePath” type=“tns:FilePathType”
              />
          <xsd:element maxOccurs=“1” minOccurs=“0”
              name=“leftBottomGraphicImagePath” type=“tns:FilePathType”
              />
          <xsd:element maxOccurs=“1” minOccurs=“0”
              name=“rightTopGraphicImagePath” type=“tns:FilePathType” />
          <xsd:element maxOccurs=“1” minOccurs=“0”
              name=“rightCenterGraphicImagePath” type=“tns:FilePathType”
              />
          <xsd:element maxOccurs=“1” minOccurs=“0”
              name=“rightBottomGraphicImagePath” type=“tns:FilePathType”
              />
          <xsd:element maxOccurs=“1” minOccurs=“0”
              name=“centerTopGraphicImagePath” type=“tns:FilePathType”
              />
          <xsd:element maxOccurs=“1” minOccurs=“0”
              name=“centerBottomGraphicImagePath”
              type=“tns:FilePathType” />
          <xsd:element maxOccurs=“1” minOccurs=“0”
              name=“centerCenterGraphicImagePath”
              type=“tns:FilePathType” />
          </xsd:sequence>
        </xsd:complexType>
      - <xsd:complexType name=“CMPSOrderResponseType”>
        - <xsd:sequence>
              <xsd:element name=“responseDate” type=“xsd:dateTime” />
          <xsd:element name=“responseStatus”
              type=“tns:ResponseStatusType” />
          <xsd:element maxOccurs=“1” minOccurs=“0”
              name=“responseMessage” type=“xsd:string” />
          <xsd:element name=“orderInformation”
              type=“tns:OrderInformationType” />
          </xsd:sequence>
        </xsd:complexType>
      - <xsd:complexType name=“OrderInformationType”>
        - <xsd:sequence>
          <xsd:element name=“cmpsOrderID” type=“xsd:int” />
          <xsd:element name=“divisionOrderID”
              type=“tns:DivisionOrderIDType” />
          <xsd:element name=“divisionID” type=“tns:DivisionIDType” />
          <xsd:element maxOccurs=“1” minOccurs=“1”
              name=“cmpsOrderItems”
              type=“tns:OrderItemInformationArrayType” />
          </xsd:sequence>
        </xsd:complexType>
      - <xsd:complexType name=“OrderItemInformationArrayType”>
        - <xsd:sequence>
          <xsd:element maxOccurs=“unbounded” minOccurs=“1”
              name=“cmpsOrderItem” type=“tns:OrderItemInformationType”
              />
          </xsd:sequence>
        </xsd:complexType>
      - <xsd:complexType name=“OrderItemInformationType”>
        - <xsd:sequence>
          <xsd:element name=“cmpsOrderItemID” type=“xsd:int” />
          <xsd:element name=“divisionProductID” type=“xsd:string” />
          <xsd:element name=“cmpsProductID” type=“xsd:int” />
          <xsd:element name=“status” type=“xsd:string” />
          <xsd:element name=“trackingNumber” type=“xsd:string” />
          <xsd:element name=“shipDate” type=“xsd:dateTime” />
          </xsd:sequence>
        </xsd:complexType>
      - <xsd:complexType name=“LookupCMPSOrderRequestType”>
        - <xsd:sequence>
          <xsd:element maxOccurs=“1” minOccurs=“0” name=“cmpsOrderID”
              type=“xsd:int” />
          <xsd:element maxOccurs=“1” minOccurs=“0”
              name=“divisionOrderID” type=“tns:DivisionOrderIDType” />
          <xsd:element maxOccurs=“1” minOccurs=“0” name=“dateRange”
              type=“tns:DateRange” />
          <xsd:element maxOccurs=“1” minOccurs=“0” name=“searchBy”
              type=“xsd:string” />
          <xsd:element maxOccurs=“1” minOccurs=“1” name=“divisionID”
              type=“tns:DivisionIDType” />
          </xsd:sequence>
        </xsd:complexType>
      - <xsd:complexType name=“LookupCMPSOrderResponseType”>
        - <xsd:sequence>
          <xsd:element maxOccurs=“1” minOccurs=“0”
              name=“responseMessage” type=“xsd:string” />
          <xsd:element maxOccurs=“1” minOccurs=“1” name=“orders”
              type=“tns:OrderInformationArrayType” />
          </xsd:sequence>
        </xsd:complexType>
      - <xsd:complexType name=“OrderInformationArrayType”>
        - <xsd:sequence>
          <xsd:element maxOccurs=“unbounded” minOccurs=“1”
              name=“cmpsOrder” type=“tns:OrderInformationType” />
          </xsd:sequence>
          </xsd:complexType>
      - <xsd:complexType name=“CreateProductRequestType”>
        - <xsd:sequence>
          <xsd:element maxOccurs=“1” minOccurs=“1” name=“divisionID”
              type=“tns:DivisionIDType” />
          <xsd:element maxOccurs=“1” minOccurs=“1”
              name=“divisionProductID” type=“tns:DivisionProductIDType” />
          <xsd:element maxOccurs=“1” minOccurs=“1”
              name=“productInformation” type=“tns:ProductInformationType”
              />
          </xsd:sequence>
        </xsd:complexType>
      - <xsd:complexType name=“ProductInformationType”>
        - <xsd:sequence>
          <xsd:element name=“sku” type=“xsd:string” />
          <xsd:element name=“description”
              type=“tns:ProductDescriptionType” />
          <xsd:element name=“productName” type=“xsd:string” />
          <xsd:element name=“mediaServiceType”
              type=“tns:MediaServiceType” />
          <xsd:element name=“mediaFormatType”
              type=“tns:MediaFormatType” />
          <xsd:element name=“partNumber” type=“xsd:string” />
          <xsd:element name=“price” type=“xsd:float” />
          <xsd:element name=“currency” type=“tns:CurrencyType” />
          <xsd:element name=“supportEmail” type=“xsd:string” />
          <xsd:element name=“applicationFileName” type=“xsd:string” />
          <xsd:element name=“imageFileName” type=“xsd:string” />
          <xsd:element maxOccurs=“1” minOccurs=“0”
              name=“downloadURL” type=“xsd:string” />
          <xsd:element maxOccurs=“1” minOccurs=“0” name=“language”
              type=“tns:LanguageType” />
          <xsd:element maxOccurs=“1” minOccurs=“0” name=“checksum”
              type=“xsd:string” />
          <xsd:element maxOccurs=“1” minOccurs=“0” name=“expanded”
              type=“xsd:boolean” />
          </xsd:sequence>
        </xsd:complexType>
      - <xsd:complexType name=“CreateProductResponseType”>
        - <xsd:sequence>
          <xsd:element maxOccurs=“1” minOccurs=“0”
              name=“responseMessage” type=“xsd:string” />
          <xsd:element maxOccurs=“1” minOccurs=“0”
              name=“cmpsProductID” type=“xsd:string” />
          </xsd:sequence>
        </xsd:complexType>
      - <xsd:complexType name=“UpdateProductRequestType”>
        - <xsd:sequence>
          <xsd:element maxOccurs=“1” minOccurs=“1” name=“divisionID”
              type=“tns:DivisionIDType” />
          <xsd:element maxOccurs=“1” minOccurs=“0”
              name=“cmpsProductID” type=“xsd:string” />
          <xsd:element maxOccurs=“1” minOccurs=“1”
              name=“divisionProductID” type=“tns:DivisionProductIDType” />
          <xsd:element maxOccurs=“1” minOccurs=“0”
              name=“productStatus” type=“tns:ProductStatusType” />
          <xsd:element maxOccurs=“1” minOccurs=“1”
              name=“productInformation” type=“tns:ProductInformationType”
              />
          </xsd:sequence>
        </xsd:complexType>
      - <xsd:complexType name=“UpdateProductResponseType”>
        - <xsd:sequence>
          <xsd:element maxOccurs=“1” minOccurs=“0”
              name=“responseMessage” type=“xsd:string” />
          </xsd:sequence>
        </xsd:complexType>
      - <xsd:complexType name=“LookupProductRequestType”>
        - <xsd:sequence>
          <xsd:element maxOccurs=“1” minOccurs=“1” name=“divisionID”
              type=“tns:DivisionIDType” />
          <xsd:element maxOccurs=“1” minOccurs=“1”
              name=“divisionProductID” type=“tns:DivisionProductIDType” />
          </xsd:sequence>
        </xsd:complexType>
      - <xsd:complexType name=“LookupProductResponseType”>
        - <xsd:sequence>
          <xsd:element maxOccurs=“1” minOccurs=“0”
              name=“responseMessage” type=“xsd:string” />
          <xsd:element maxOccurs=“1” minOccurs=“1”
              name=“productInformation” type=“tns:ProductInformationType”
              />
          </xsd:sequence>
        </xsd:complexType>
      - <xsd:complexType name=“UpdateCMPSOrderStatusRequestType”>
        - <xsd:sequence>
          <xsd:element maxOccurs=“1” minOccurs=“0” name=“divisionID”
              type=“xsd:string” />
          <xsd:element maxOccurs=“1” minOccurs=“0”
              name=“divisionOrderID” type=“xsd:string” />
          <xsd:element maxOccurs=“1” minOccurs=“0” name=“cmpsOrderID”
              type=“xsd:int” />
          <xsd:element maxOccurs=“1” minOccurs=“1”
              name=“cmpsOrderItems”
          type=“tns:OrderItemInformationArrayType” />
          </xsd:sequence>
        </xsd:complexType>
      - <xsd:complexType name=“UpdateCMPSOrderStatusResponseType”>
        - <xsd:sequence>
          <xsd:element maxOccurs=“1” minOccurs=“0”
              name=“responseMessage” type=“xsd:string” />
          </xsd:sequence>
        </xsd:complexType>
      - <xsd:complexType name=“ReburnOrderRequestType”>
        - <xsd:sequence>
          <xsd:element maxOccurs=“1” minOccurs=“0”
              name=“divisionOrderID” type=“tns:DivisionOrderIDType” />
          <xsd:element maxOccurs=“1” minOccurs=“0” name=“cmpsOrderID”
              type=“xsd:int” />
          <xsd:element maxOccurs=“1” minOccurs=“1” name=“divisionID”
              type=“tns:DivisionIDType” />
          </xsd:sequence>
        </xsd:complexType>
      - <xsd:complexType name=“ReburnOrderResponseType”>
        - <xsd:sequence>
          <xsd:element name=“responseStatus”
              type=“tns:ResponseStatusType” />
          <xsd:element name=“cmpsOrderID” type=“xsd:int” />
          </xsd:sequence>
        </xsd:complexType>
      - <xsd:simpleType name=“DivisionIDType”>
        - <xsd:restriction base=“xsd:string”>
          <xsd:minLength value=“1” />
          <xsd:maxLength value=“64” />
          <xsd:whiteSpace value=“collapse” />
          </xsd:restriction>
        </xsd:simpleType>
      - <xsd:simpleType name=“DivisionOrderIDType”>
        - <xsd:restriction base=“xsd:string”>
          <xsd:minLength value=“1” />
          <xsd:maxLength value=“64” />
          <xsd:whiteSpace value=“collapse” />
          </xsd:restriction>
        </xsd:simpleType>
      - <xsd:simpleType name=“DivisionProductIDType”>
        - <xsd:restriction base=“xsd:string”>
          <xsd:minLength value=“1” />
          <xsd:maxLength value=“64” />
          <xsd:whiteSpace value=“collapse” />
          </xsd:restriction>
        </xsd:simpleType>
      - <xsd:simpleType name=“ShippingMethodIDType”>
        - <xsd:restriction base=“xsd:string”>
          <xsd:minLength value=“1” />
          <xsd:maxLength value=“64” />
          <xsd:whiteSpace value=“collapse” />
          </xsd:restriction>
        </xsd:simpleType>
      - <xsd:simpleType name=“MediaServiceType”>
        - <xsd:restriction base=“xsd:string”>
          <xsd:minLength value=“1” />
          <xsd:maxLength value=“64” />
          <xsd:whiteSpace value=“collapse” />
          </xsd:restriction>
        </xsd:simpleType>
      - <xsd:simpleType name=“MediaFormatType”>
        - <xsd:restriction base=“xsd:string”>
          <xsd:minLength value=“1” />
          <xsd:maxLength value=“64” />
          <xsd:whiteSpace value=“collapse” />
          </xsd:restriction>
        </xsd:simpleType>
      - <xsd:simpleType name=“CurrencyType”>
        - <xsd:restriction base=“xsd:string”>
          <xsd:minLength value=“1” />
          <xsd:maxLength value=“3” />
          <xsd:whiteSpace value=“collapse” />
          </xsd:restriction>
        </xsd:simpleType>
      - <xsd:simpleType name=“LanguageType”>
        - <xsd:restriction base=“xsd:string”>
          <xsd:minLength value=“1” />
          <xsd:maxLength value=“2” />
          <xsd:whiteSpace value=“collapse” />
          </xsd:restriction>
        </xsd:simpleType>
      - <xsd:simpleType name=“CountryCodeType”>
        - <xsd:restriction base=“xsd:string”>
          <xsd:minLength value=“1” />
          <xsd:maxLength value=“2” />
          <xsd:whiteSpace value=“collapse” />
          </xsd:restriction>
        </xsd:simpleType>
      - <xsd:simpleType name=“FilePathType”>
        - <xsd:restriction base=“xsd:string”>
          <xsd:minLength value=“1” />
          <xsd:maxLength value=“255” />
          <xsd:whiteSpace value=“collapse” />
          </xsd:restriction>
        </xsd:simpleType>
      - <xsd:simpleType name=“ResponseStatusType”>
        - <xsd:restriction base=“xsd:string”>
          <xsd:minLength value=“1” />
          <xsd:maxLength value=“64” />
          <xsd:whiteSpace value=“collapse” />
          </xsd:restriction>
        </xsd:simpleType>
      - <xsd:simpleType name=“ProductDescriptionType”>
        - <xsd:restriction base=“xsd:string”>
          <xsd:minLength value=“1” />
          <xsd:maxLength value=“128” />
          <xsd:whiteSpace value=“collapse” />
          </xsd:restriction>
        </xsd:simpleType>
      - <xsd:simpleType name=“ProductStatusType”>
        - <xsd:restriction base=“xsd:string”>
          <xsd:minLength value=“1” />
          <xsd:maxLength value=“64” />
          <xsd:whiteSpace value=“collapse” />
          </xsd:restriction>
        </xsd:simpleType>
      - <xsd:complexType name=“DateRange”>
        - <xsd:sequence>
          <xsd:element name=“startDate” type=“xsd:date” />
          <xsd:element name=“endDate” type=“xsd:date” />
          </xsd:sequence>
        </xsd:complexType>
      - <xsd:complexType name=“CMPSFaultType”>
        - <xsd:sequence>
          <xsd:element maxOccurs=“1” minOccurs=“0” name=“cause”
              type=“xsd:string” />
          <xsd:element maxOccurs=“1” minOccurs=“0” name=“message”
              type=“xsd:string” />
          <xsd:element maxOccurs=“1” minOccurs=“0” name=“errorTime”
              type=“xsd:date” />
          </xsd:sequence>
        </xsd:complexType>
        <xsd:element name=“CMPSFaultElement” type=“tns:CMPSFaultType” />
    </xsd:schema>
    </wsdl:types>
  - <wsdl:message name=“CMPSFault”>
      <wsdl:part name=“CMPSFaultPart” element=“tns:CMPSFaultElement” />
    </wsdl:message>
  - <wsdl:message name=“lookupCMPSOrderMessage”>
      <wsdl:part name=“lookupRequest” type=“tns:LookupCMPSOrderRequestType” />
    </wsdl:message>
  - <wsdl:message name=“lookupProductMessage”>
      <wsdl:part name=“lookupProductRequest” type=“tns:LookupProductRequestType”
          />
    </wsdl:message>
  - <wsdl:message name=“updateCMPSOrderStatusMessage”>
      <wsdl:part name=“updateCMPSOrderStatusRequest”
        type=“tns:UpdateCMPSOrderStatusRequestType” />
    </wsdl:message>
  - <wsdl:message name=“createProductResponseMessage”>
      <wsdl:part name=“createProductResponse”
        type=“tns:CreateProductResponseType” />
    </wsdl:message>
  - <wsdl:message name=“updateProductMessage”>
      <wsdl:part name=“updateProductRequest” type=“tns:UpdateProductRequestType”
        />
    </wsdl:message>
  - <wsdl:message name=“reburnOrderMessage”>
      <wsdl:part name=“reburnOrderRequest” type=“tns:ReburnOrderRequestType” />
    </wsdl:message>
  - <wsdl:message name=“updateProductResponseMessage”>
      <wsdl:part name=“updateProductResponse”
        type=“tns:UpdateProductResponseType” />
    </wsdl:message>
  - <wsdl:message name=“lookupCMPSOrderResponseMessage”>
      <wsdl:part name=“lookupResponse” type=“tns:LookupCMPSOrderResponseType”
        />
    </wsdl:message>
  - <wsdl:message name=“reburnOrderResponseMessage”>
      <wsdl:part name=“reburnOrderResponse” type=“tns:ReburnOrderResponseType”
        />
    </wsdl:message>
  - <wsdl:message name=“createCMPSOrderResponseMessage”>
      <wsdl:part name=“orderResponse” type=“tns:CMPSOrderResponseType” />
    </wsdl:message>
  - <wsdl:message name=“createCMPSOrderMessage”>
      <wsdl:part name=“orderRequest” type=“tns:CMPSOrderRequestType” />
    </wsdl:message>
  - <wsdl:message name=“createProductMessage”>
      <wsdl:part name=“createProductRequest” type=“tns:CreateProductRequestType” />
    </wsdl:message>
  - <wsdl:message name=“updateCMPSOrderStatusResponseMessage”>
      <wsdl:part name=“updateCMPSOrderStatusResponse”
        type=“tns:UpdateCMPSOrderStatusResponseType” />
    </wsdl:message>
  - <wsdl:message name=“lookupProductResponseMessage”>
      <wsdl:part name=“lookupProductResponse”
        type=“tns:LookupProductResponseType” />
    </wsdl:message>
  - <wsdl:portType name=“CMPSWebServicePortType”>
    - <wsdl:operation name=“createCMPSOrder”>
      <wsdl:input name=“cmpsOrderRequest”
          message=“tns:createCMPSOrderMessage” />
      <wsdl:output name=“cmpsOrderResponse”
          message=“tns:createCMPSOrderResponseMessage” />
      <wsdl:fault name=“CMPSFault” message=“tns:CMPSFault” />
      </wsdl:operation>
    - <wsdl:operation name=“lookupCMPSOrder”>
      <wsdl:input name=“lookupOrderRequest”
          message=“tns:lookupCMPSOrderMessage” />
      <wsdl:output name=“lookupOrderResponse”
          message=“tns:lookupCMPSOrderResponseMessage” />
      <wsdl:fault name=“CMPSFault” message=“tns:CMPSFault” />
      </wsdl:operation>
    - <wsdl:operation name=“updateCMPSOrderStatus”>
      <wsdl:input name=“updateCMPSOrderStatusRequest”
          message=“tns:updateCMPSOrderStatusMessage” />
      <wsdl:output name=“updateCMPSOrderStatusResponse”
          message=“tns:updateCMPSOrderStatusResponseMessage” />
      <wsdl:fault name=“CMPSFault” message=“tns:CMPSFault” />
      </wsdl:operation>
    - <wsdl:operation name=“createProduct”>
      <wsdl:input name=“createProductRequest”
          message=“tns:createProductMessage” />
      <wsdl:output name=“createProductResponse”
          message=“tns:createProductResponseMessage” />
      <wsdl:fault name=“CMPSFault” message=“tns:CMPSFault” />
      </wsdl:operation>
    - <wsdl:operation name=“lookupProduct”>
      <wsdl:input name=“lookupProductRequest”
          message=“tns:lookupProductMessage” />
      <wsdl:output name=“lookupProductResponse”
          message=“tns:lookupProductResponseMessage” />
      <wsdl:fault name=“CMPSFault” message=“tns:CMPSFault” />
      </wsdl:operation>
    - <wsdl:operation name=“updateProduct”>
      <wsdl:input name=“updateProductRequest”
          message=“tns:updateProductMessage” />
      <wsdl:output name=“updateProductResponse”
          message=“tns:updateProductResponseMessage” />
      <wsdl:fault name=“CMPSFault” message=“tns:CMPSFault” />
      </wsdl:operation>
    - <wsdl:operation name=“reburnOrder”>
      <wsdl:input name=“reburnOrderRequest”
          message=“tns:reburnOrderMessage” />
      <wsdl:output name=“reburnOrderResponse”
          message=“tns:reburnOrderResponseMessage” />
      <wsdl:fault name=“CMPSFault” message=“tns:CMPSFault” />
      </wsdl:operation>
    </wsdl:portType>
  - <wsdl:binding name=“CMPSWebServiceHttpBinding”
      type=“tns:CMPSWebServicePortType”>
      <wsdlsoap:binding style=“document”
        transport=“http://schemas.xmlsoap.org/soap/http” />
    - <wsdl:operation name=“createCMPSOrder”>
        <wsdlsoap:operation soapAction=“createCMPSOrder” style=“document” />
      - <wsdl:input name=“cmpsOrderRequest”>
        <wsdlsoap:body use=“literal” />
        </wsdl:input>
      - <wsdl:output name=“cmpsOrderResponse”>
        <wsdlsoap:body use=“literal” />
        </wsdl:output>
      </wsdl:operation>
    - <wsdl:operation name=“lookupCMPSOrder”>
      <wsdlsoap:operation soapAction=“lookupCMPSOrder” style=“document” />
      - <wsdl:input name=“lookupOrderRequest”>
        <wsdlsoap:body use=“literal” />
        </wsdl:input>
      - <wsdl:output name=“lookupOrderResponse”>
        <wsdlsoap:body use=“literal” />
        </wsdl:output>
      </wsdl:operation>
    - <wsdl:operation name=“updateCMPSOrderStatus”>
      <wsdlsoap:operation soapAction=“updateCMPSOrderStatus”
        style=“document” />
      - <wsdl:input name=“updateCMPSOrderStatusRequest”>
        <wsdlsoap:body use=“literal” />
        </wsdl:input>
      - <wsdl:output name=“updateCMPSOrderStatusResponse”>
        <wsdlsoap:body use=“literal” />
        </wsdl:output>
      </wsdl:operation>
    - <wsdl:operation name=“createProduct”>
      <wsdlsoap:operation soapAction=“createProduct” style=“document” />
      - <wsdl:input name=“createProductRequest”>
        <wsdlsoap:body use=“literal” />
        </wsdl:input>
      - <wsdl:output name=“createProductResponse”>
        <wsdlsoap:body use=“literal” />
        </wsdl:output>
      </wsdl:operation>
    - <wsdl:operation name=“updateProduct”>
      <wsdlsoap:operation soapAction=“updateProduct” style=“document” />
        - <wsdl:input name=“updateProductRequest”>
        <wsdlsoap:body use=“literal” />
        </wsdl:input>
      - <wsdl:output name=“updateProductResponse”>
        <wsdlsoap:body use=“literal” />
        </wsdl:output>
      </wsdl:operation>
    - <wsdl:operation name=“lookupProduct”>
      <wsdlsoap:operation soapAction=“lookupProduct” style=“document” />
      - <wsdl:input name=“lookupProductRequest”>
        <wsdlsoap:body use=“literal” />
        </wsdl:input>
      - <wsdl:output name=“lookupProductResponse”>
        <wsdlsoap:body use=“literal” />
        </wsdl:output>
      </wsdl:operation>
    - <wsdl:operation name=“reburnOrder”>
      <wsdlsoap:operation soapAction=“reburnOrder” style=“document” />
      - <wsdl:input name=“reburnOrderRequest”>
        <wsdlsoap:body use=“literal” />
        </wsdl:input>
      - <wsdl:output name=“reburnOrderResponse”>
        <wsdlsoap:body use=“literal” />
        </wsdl:output>
      </wsdl:operation>
    </wsdl:binding>
  - <wsdl:service name=“CMPSWebService”>
    - <wsdl:port name=“CMPSWebServiceHttpPort”
        binding=“tns:CMPSWebServiceHttpBinding”>
      <wsdlsoap:address location=“http://cmps.digitalriver.com/cmps-
        1.0/services/CMPSWebService” />
    </wsdl:port>
  </wsdl:service>
</wsdl:definitions>
```

Transactions may be processed through the system in real time. Messages flow from the e-commerce system 102 to the CMPS 100; CMPS 100 provides a response 212 but does not initiate messages to the e-commerce system 102. Messages flow to and from the vendor system 214, 216. The CMPS 100 provides the fulfillment messages, and product feed; the vendor 106 responds with acknowledgment to fulfillment messages and provides updates on fulfillment status. Alternatively, the system may spool incoming requests for batch processing at a later time.

Referring to FIG. 2, the CMPS web service module 204 provides the framework for high level validation in the wsdl and calls an implementation accessed through the wsdl and converts the XML into data structures. The data is parsed and mapped to tables in the CMPS database 202, converting it into the data objects that may be used by the business logic module. The business logic component 206 takes the incoming message data, performs validation checks for business rules and translates the message. By interpreting the contents of the message, this component determines to which vendor the fulfillment request should be directed. When the message passes validation, the data is parsed and a record is written to the database 202. The business logic module 206 may also contain tools related to provision of bundled trial software. For example, purchase of software X may be configured in the e-commerce system to include trial versions of software Y and Z. A rules engine in the business logic module might locate those products in order to provide the URL or other location indicator to the vendor. Providing this functionality in the business logic of the centralized system eliminates the need to update each and every e-commerce platform used by the manufacturer.

A fulfillment adapter component 208 gathers the data required for the fulfillment request and formats it into an outgoing message 214, if one is required depending on the message received. Vendor adapters 210 may be created for any vendor which has specific requirements for the messages they receive. These adapters supplement the service provided by the fulfillment adapter 208. For example, if a vendor 106 wishes to restrict the particular time of day that messages are sent to it, or wishes to only receive messages on demand (manually triggered), the appropriate logic can be included in the vendor adapter 210.

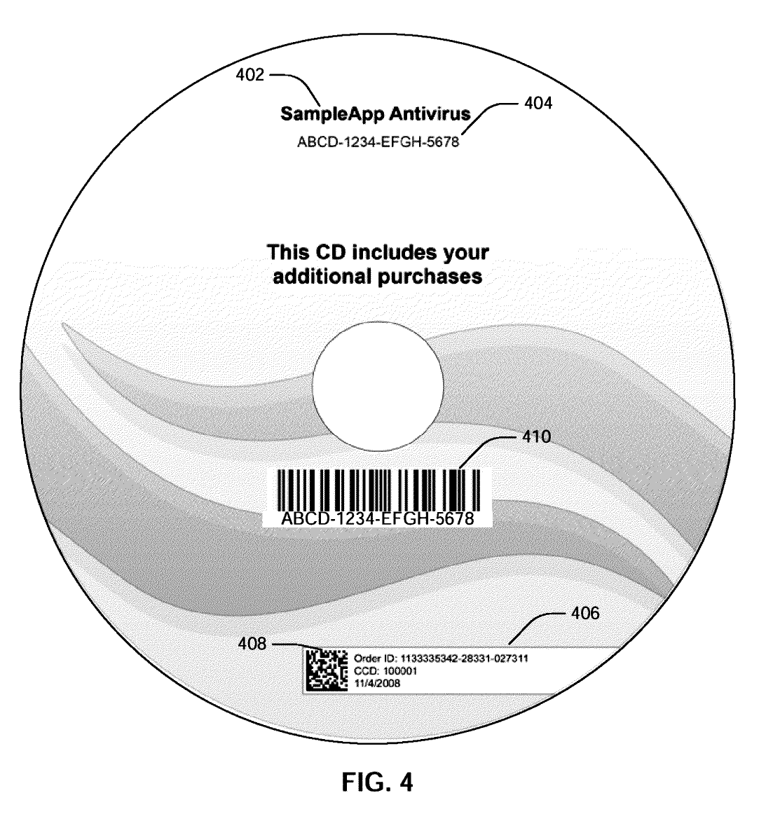

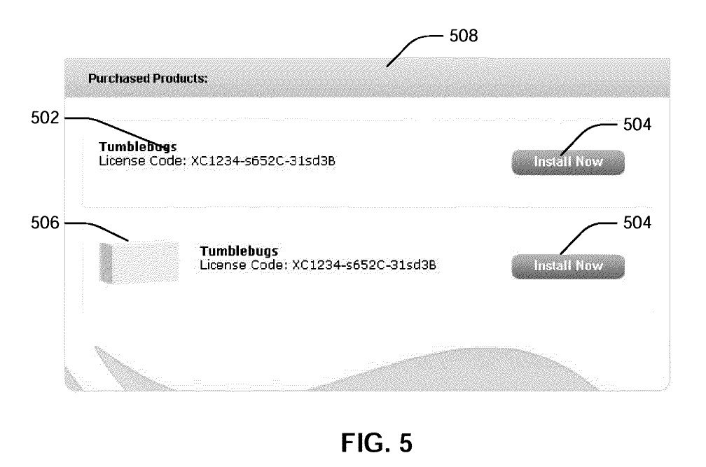

Data sent to the fulfillment center includes a product feature set that may consist of items such as the CD or DVD face design (FIG. 4), autorun disc menu (FIG. 5), instructions for order level and product level back up, media capacity guidelines and shipping instructions. A default graphic, such as the one pictured in FIG. 4 may be indicated, or the manufacturer may upload an image file to be used for all or specific products. The outgoing message then may provide the vendor with the location (e.g. a URL) for the graphic. Default text printed on each disc may include such identifying text as product name 402, registration code 404, platform order ID 406, tracking ID 408 and barcode 410. Like the default graphic, default text may be overridden by implementing an associated element, such as “DiscLabel,” from the CMPS wsdl.

Referring to FIG. 5, The autorun disc menu may include a row 502 for each product with identifying information such as product name, license code, serial number, launch/install/run buttons 504, and the product logo 506, if desired. The header image 508 for the menu may be customized at the order level. Trial versions of software and offer and other advertising graphics may also be added to the menu. Additional text may be added at both the order or product level, by including the text in the appropriate message.

Data sent to fulfillment center can also include instructions for whether back up is completed at the order (all items go on one CD or DVD) or the product (one product per CD or DVD or disc set) level. Media constraints may apply; current media capacities are 714 MB for a CD and 4.5 GB for a DVD, however, this is a flexible value. The default may be a product level back up, where a product is burned to CD unless it exceeds the CD capacity limit; otherwise it will be burned to DVD. If the product exceeds the DVD limit, the order may go into an error state for resolution. An order level back up burns all of the items on the same order on the same disc following the media capacity constraints. CD/DVDs may be shipped according to fulfillment vendor contract or the most appropriate way depending on the shipping destination.

Because of the flexible modular design, additional e-commerce platforms or vendors may be easily added. Instead of tying to a direct integration with a specific vendor, e-commerce sellers and manufacturers may locate the partner that works best for their needs and have it integrated into the system with only minor data updates (i.e. additional vendor code for the vendor adapter) and end to end testing.

### Use Case

An example constructed after FIG. 1, serves to demonstrate an implementation of a preferred embodiment of the invention. In this example, a popular software manufacturer (the manufacturer) sells downloadable software on its e-commerce site. The manufacturer sells software in many languages, to a multitude of locations across the world. The manufacturer has an online store run by an e-commerce service provider with several platforms 102. The manufacturer's stores are hosted cross-platform. The manufacturer offers an option to consumers to purchase a CD copy of any downloaded software they purchase. When the consumer purchases the physical copy and completes order checkout, the platform calls an application programming interface (API) to construct a createCMPSorder request message 212, and transmits it to a CMPS 100.

The createCMPSorder request provides the order and product details, including the vendor 106 to which the order should be directed, an identification and location (e.g. URL) of the software and information that must be included on the disc, and the details of the label graphic. CMPS 100, 204 receives the message, performs validation (such as address and product information) 206, parses the data in the incoming message and loads it into a database 202. The record is successfully created, and the CMPS 100 record is updated with a SUCCESS status. The CMPS 100 returns a CMPSOrderReponse acknowledgment 212.

Once the order has been placed, the manufacturer checks the status of an order by requesting a lookup (LookupCMPSOrderRequest), or could alternatively request a complete re-burn (ReburnOrderRequest) of a product sold on an earlier order. (Messages for these functions are listed in Table 1, and sample XML messages are provided in Table 2.) In this embodiment of the invention, the CMPS 100 responds to requests from the e-commerce platform; nothing is sent, unsolicited, to the e-commerce platform from CMPS 100, 212. A person skilled in the art could recognize that this information can be sent in either direction.

The CMPS 100 transforms the data into a fulfillment (createOrderRequest) request, locates the vendor 106, and sends the fulfillment request to the vendor 106. The vendor 106 receives the request, processes it, and returns an acknowledgment of message received, or an error message. The CMPS 100 receives and processes the message by updating the status of the order in the database 202. Again, the manufacturer may request an updated status by submitting a lookup message, and the status will be returned by the lookup response.

If the product requested does not exist on the CMPS 100, it may be added at the time the createOrderRequest message is received, and then may be included in the fulfillment request sent to the vendor 106. If the vendor 106 does not have the product in its database, it returns an acknowledgment that the message has been submitted, and begins to process the order. When the process does not find the product, the vendor 106 transmits a message to the CMPS 100, requesting a process product feed via java server pages (JSP) for the product in question. The CMPS 100 transmits the JSP to the vendor, and the fulfillment process continues.

Similarly, if a product is updated, a checksum process in the message received by the vendor 106 does not match, and the vendor 106 initiates the Process product feed requests, updates the product in its database and continues with the fulfillment process. If for some reason the JSP is not available for a particular product, the vendor waits and reprocesses the message at a later time. JSP is an example of page generation technology that may be used with this system; one skilled in the art would recognize that other technologies, such as servlet or pre-generated HTML, may be used as well.

Product files could require expansion. A field in the API, a boolean field for example, may carry a value indicating that a product file must be expanded. If that flag has a value of ‘Y’, it indicates to the vendor 106 system that the file must be expanded prior to burning it onto media.

A time out may be applied to a request. If a fulfillment request is sent to a vendor 106, and the vendor 106 doesn't respond within one minute, the CMPS 100 may send an error response to the e-commerce platform, which sets the order status to REJECTED. Rejected fulfillment requests may be periodically processed either automatically or manually.

When an order has been successfully received by the vendor 106, the vendor may format and forward an orderStatus message to CMPS 100 with a status of SHIPPED. That message may provide shipping and tracking information, as well as any other pertinent information related to an order status update. When the CMPS 100 receives the message, it may update its own database to reflect the status to SHIPPED.

If the customer wishes to check the status of his order, he enters the manufacturer's web site, selects functionality to check on his order, and submits the order information to the system. The e-commerce system 102 might then send a lookupCMPSOrder message to the CMPS 100, and receive the status of the order in the response and display that to the customer.

An embodiment of this invention provides a centralized manufacturing distribution system for the creation of physical copies of software on demand. The system works with one or more e-commerce platforms and one or more vendor systems, with the ability to easily add more of each without impacting the others.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application of the centralized media production system that are organized or designed differently while maintaining substantially the same functionality without departing from the scope and spirit of the present invention.

1. A centralized media production system, comprising:
a web service configured to receive information about software product files and orders from at least one e-commerce system;
a web service configured to communicate with at least one media manufacturing system to coordinate the manufacture and distribution of media to end customers; and
a database configured to store status and other information about the media manufacturing and distribution.

2. An apparatus for on-demand distribution of software, comprising;
a web service module configured to receive an identification of order and product details from an e-commerce platform;
a database operatively configured to store order and product information;
a business logic module operatively configured to validate data received;
a fulfillment adapter module operatively configured to determine fulfillment requirements based on the received order and product details; and
a vendor adapter module operatively configure to perform special processing based on the received order and product details that are specific to a particular fulfillment vendor.

3. The apparatus of claim 2 wherein the web service module is operatively configured to receive information from at least two e-commerce platforms.

4. The apparatus of claim 2 further comprising a second vendor adapter module operatively configured to perform special processing that are specific to another fulfillment vendor.

5. The apparatus of claim 2 wherein the web service module is operatively configured to receive identification of order and product details from an e-commerce platform in real time.

6. The apparatus of claim 2 wherein the web service module is operatively configured to receive identification of order and product details from an e-commerce platform in a batch processing message comprising multiple orders and product details.

7. The apparatus of claim 2 wherein the business logic module comprises a rules engine with data associating trial offers and advertisements to product details and wherein the business logic module is operatively configured to automatically include one of: (i) an associated trial offer and (ii) an advertisement along with the product when fulfilling the order based on results from the rules engine and the received product details.

8. The apparatus of claim 2 further comprising a reporting module operatively configured to provide transactional reporting.

9. A method of centralizing online ordering and fulfillment of products comprising steps of:
processing a received electronic order and product details from an e-commerce system to generate a fulfillment request message for one of a first and second fulfillment vendor;
transmitting the fulfillment request message to the first fulfillment vendor;
receiving a fulfillment response message from the first fulfillment vendor; and
storing data from the order and fulfillment response in a database.

10. The method of claim 9 wherein the processing step comprises utilizing the received product details and a rules engine, where the rules engine comprises data associating trial offers and advertisements with product details, to identify an offer to include with the order such that at least one of: (i) an associated trial offer and (ii) an advertisement is associated with the product when fulfilling the order.

11. The method of claim 9 further comprising a reporting step which generates a report related to orders and fulfillment records across multiple e-commerce platforms and fulfillment vendors.

12. The method of claim 9 wherein the transmitting the fulfillment request step comprises a location of graphics for use in labeling media by the particular fulfillment vendor.

13. The method of claim 9 wherein the transmitting the fulfillment request step comprises a location of a product for use in creating media by the particular fulfillment vendor.

14. The apparatus of claim 2 wherein the product details comprise a location of graphics for use in labeling media by the particular fulfillment vendor.

15. The apparatus of claim 2 wherein the product details comprise a location of a product for use in creating media by the particular fulfillment vendor.
